(19) United States
(12) Patent Application Publication
(10) Pub. No.: US 2026/0158429 A1
(43) Pub. Date: Jun. 11, 2026

(54) FILTER ELEMENT

(71) Applicant: Haiou Tang, Shaoyang (CN)

(72) Inventor: Haiou Tang, Shaoyang (CN)

(21) Appl. No.: 18/981,918

(22) Filed: Dec. 16, 2024

(30) Foreign Application Priority Data
Dec. 10, 2024 (CN) 202423039193.X

(51) Int. Cl. B01D 46/52; B01D 46/00

(52) U.S. Cl. CPC B01D 46/523; B01D 46/0005; B01D 2265/025; B01D 2265/06

(57) ABSTRACT

The present application discloses a filter element comprising four borders, four corner codes and a screen cloth, wherein four of the borders are connected end to end successively and form a closed rectangular frame, four of the corner codes are arranged respectively at the corner position of the rectangular frame, each of the corner codes is used to connect two adjacent borders, and the screen cloth is arranged in the rectangular frame. Thus, the four borders are connected end to end to form a closed rectangular frame, and the four corner codes are connected and reinforced in the corner position of the rectangular frame, with the internal filter cloth to enhance the stability and durability of the entire filter element structure, improve the filter cloth filtration efficiency, not only extend the service life of the filter element, but also facilitate maintenance and replacement.

### CROSS-REFERENCE TO RELATED APPLICATIONS

This application claims priority to Chinese Patent Application No. 202423039193.X, filed on Dec. 10, 2024, which is hereby incorporated by reference in its entirety.

### TECHNICAL FIELD

The present application relates to the technical field of filtration, in particular to a filter element.

### BACKGROUND

In modern industrial production and daily life, the application of air filtration technology is increasingly extensive and vital, and the filter element as the core component of the air filtration system, its performance and structure directly affect the effect and quality of air filtration.

Traditional air filter technology in the process of continuous development has shown its own characteristics and limitations, such as fiber filter material with its large specific surface area and rich pore structure, can effectively capture the small particles in the air, but with the growth of the use of time, the fiber is prone to agglomeration and hardening phenomenon, resulting in a sharp rise in filtration resistance, air passing rate significantly reduced. Not only increases energy consumption, but also shortens the service life of the filter element;

Plate filter element structure is relatively simple, the production cost is low, in some of the filtration requirements are not high occasions to be applied, but its filtration area is limited, for high concentration of pollutants or fine filtration needs are difficult to meet, the filtration efficiency is low, can not effectively remove fine particles and harmful gases in the air;

In the industrial field, such as electronic chip manufacturing workshop, the air quality requirements are extremely high, even trace particles of impurities may lead to chip short circuit or performance decline, the traditional filter element is difficult to provide stable to meet the requirements of ultra-clean air;

Therefore, in order to adapt to the diverse needs of air filtration in different fields and further improve air quality, it is of practical significance to develop a new filter element with high efficiency filtration performance, good structural stability, long life and easy maintenance.

### SUMMARY

The present application is intended to solve at least to a certain extent one of the technical problems in the above techniques.

Therefore, one purpose of the present application is to propose a filter element, which forms a closed rectangular frame by connecting four borders end to end, and uses four corner codes to connect and strengthen the corner position of the rectangular frame, and enhances the stability and durability of the entire filter element structure with the internal filter cloth, which can make the filter cloth better unfold and maintain its shape, and improve the filtration efficiency of the filter cloth. It not only prolonging the service life of the filter element, but also easy to maintain and replace, and meet the application needs of different occasions, especially those with high requirements for air quality.

To achieve the above purpose, embodiments of the first aspect of the present application provide a filter element, which comprises: four borders, four corner codes and a filter cloth, among which,

Four of the borders are connected end to end and form a closed rectangular frame, four of the corner code are arranged in the corner position of the rectangular frame, each of the corner code is used to connect two adjacent borders, the filter cloth is arranged in the rectangular frame.

According to the embodiment of the filter element of the present application, the four borders are connected end to end to form a closed rectangular frame, and the four corner codes are connected and reinforced at the corner position of the rectangular frame, and the stability and durability of the entire filter element structure are enhanced with the internal filter cloth, which can make the filter cloth better unfold and maintain the shape, improve the filtering efficiency of the filter cloth, and prolong the service life of the filter element. It is also convenient for maintenance and replacement, and can meet the application requirements of different occasions, especially those with high requirements for air quality.

In addition, the filter element according to the embodiments of the present application may also have the following additional technical characteristics:

As a possibility, the frame is provided with a long slate-like main body part, the two sides of the main body part are respectively provided with a side plate, the main body part and the side plate are vertical, the main body part and the side plate is provided with a first chute at the joint of the main body part and the side plate is provided with a second chute at the joint of the main body part and the side plate. The main body part is provided with a limited bit hole.

As a possibility, the side edge of the corner code is provided with a slide rail, the corner code is provided with an elastic sheet, the elastic sheet is provided with a finite bit block, when the corner code is connected to the two adjacent borders, the slide rail is stuck in the first chute, and the elastic sheet pushes the limit block is stuck in the limit hole.

As a possibility, the filter cloth is a wave folding shape, the two sides of the filter cloth are arranged with a support plate, when the filter cloth is arranged in the rectangular frame, the support plate is arranged on an adjacent frame, and the edge of the support plate is stuck in the second chute.

As a possibility, the main body part and the two sides are formed in one body.

As a possibility, a stiffener is arranged on the corner code.

As a possibility, a stiffener plate is provided at the bend of the corner code.

As a possibility, the strainer cloth is bonded to the support plate.

As a possibility, at least one of the two faces of the screen cloth is provided with a metal spacer.

As a possibility, at least one of the two faces of the filter cloth is provided with a finite bit belt, and the two ends of the limit belt are respectively connected with the two support plates, and the main part of the limit belt is connected with the fold of the filter cloth.

Additional aspects and advantages of the present application will be partly given in the following description, and some will become apparent from the description below, or will be learned through the practice of the present application.

### BRIEF DESCRIPTION OF DRAWINGS

The above additional aspects and advantages of the present application will become apparent and easily understood from the following descriptions of embodiments in conjunction with the drawings, where:

FIG. 1 is a structural diagram of a filter element of one embodiment of the present application;

FIG. 2 is a structural diagram of a border of an embodiment of the present application;

FIG. 3 is an enlarged diagram of part A of a border of an embodiment of the present application;

FIG. 4 is a cross-section diagram of a border of one embodiment of the present application;

FIG. 5 is a structural diagram of corner code of one embodiment of the present application;

FIG. 6 is structural schematic diagram II of corner code of one embodiment of the present application;

FIG. 7 is structural schematic diagram 3 of corner code of one embodiment of the present application;

FIG. 8 is the structural diagram of corner code of one embodiment of the present application;

FIG. 9 is a structural diagram of a filter cloth for an embodiment of the present application.

As shown in the figure:
1—Border;
11—body part, 12—side panels, 13—first chute, 14—second chute, 15—limit hole.
2—corner code;
21—slide rail, 22—elastic piece, 23—limit block, 24—stiffener, 25—stiffener;
3—strainer cloth;
31—support plate, 32—metal spacer, 33—limit tape.

### DESCRIPTION OF EMBODIMENTS

Examples of embodiments of the present application are described in detail below, examples of which are shown in the attached drawings, where identical or similar labels from beginning to end indicate identical or similar elements or elements having the same or similar function. The embodiments described below by reference to the attached drawings are illustrative and are intended to be used for interpretation of the present application and are not to be understood as limitations of the present application.

The filter element of the embodiment of the present application is described below by reference to the attached drawing.

### Embodiment 1

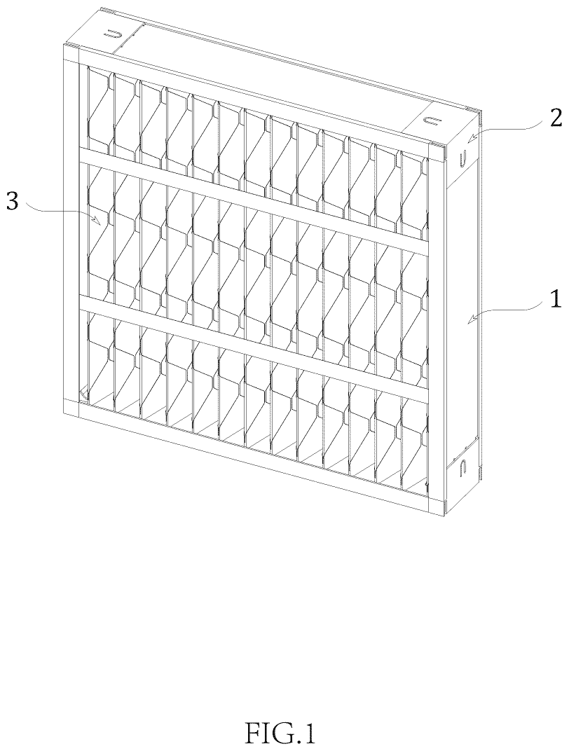

As shown in FIG. 1, the filter element comprises: four borders 1, four corner codes 2 and the filter cloth 3, wherein,

The four borders 1 are connected end to end to form a closed rectangular frame, the four corner codes 2 are arranged at the corner of the rectangular frame, each corner code 2 is used to connect the two adjacent borders 1, and the filter cloth 3 is arranged in the rectangular frame.

In the embodiment of the present application, the overall structure of the filter element is designed to solve the shortcomings of the existing filter element in terms of stability, filtration efficiency and maintenance convenience, etc. The four borders 1 are connected end to end to form a rectangular frame, which provides a basic supporting frame for the entire filter element to ensure its shape is stable, and the four corner codes 2 are connected and reinforced at the corner of the rectangular frame. Further enhance the stability of the frame, prevent deformation and other problems in the use process, the filter cloth 3 is set in the rectangular frame, through the joint action of the frame 1 and corner code 2, can better unfold and maintain its shape, so as to improve the filtration efficiency.

It should be noted that the frame 1 as the main support part of the filter element, its structural design has an important impact on the performance of the entire filter element, the length, width and thickness of the frame 1 can be customized according to the actual application needs, for example, in the space is limited but the filter efficiency requirements are higher occasions, you can appropriately increase the height of the frame 1 to accommodate more folded filter cloth 3, In order to increase the filtration area, the shape and size of corner code 2 are matched with the frame 1, the material can be selected with a certain strength and toughness of plastic or metal, to ensure the fastness of the connection, the material of the filter cloth 3 can be selected according to the different filter objects, such as the filtration of fine particles can choose efficient HEPA filter paper, For the filtration of harmful gases can be selected activated carbon fiber filter paper.

According to the filter element disclosed in the present application, four borders 1 are connected end to end to form a closed rectangular frame, and four corner code 2 is used to connect and strengthen the corner position of the rectangular frame, and the stability and durability of the entire filter element structure is enhanced with the internal filter cloth 3, which can make the filter cloth 3 better unfold and maintain its shape, and improve the filtration efficiency of the filter cloth 3. It not only prolonging the service life of the filter element, but also facilitates maintenance and replacement, and meets the application needs of different occasions, especially those with high requirements for air quality.

### Embodiment 2

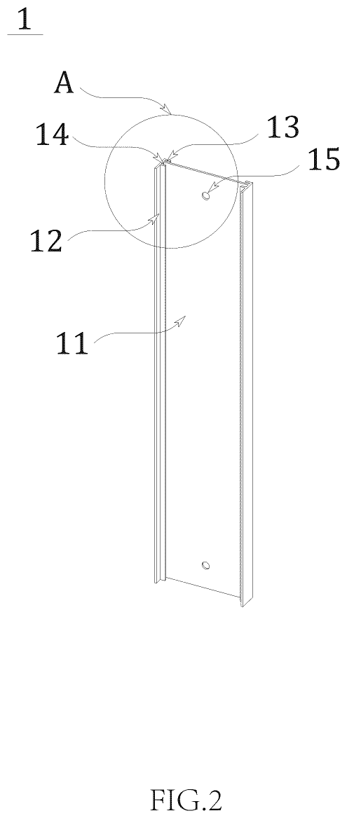

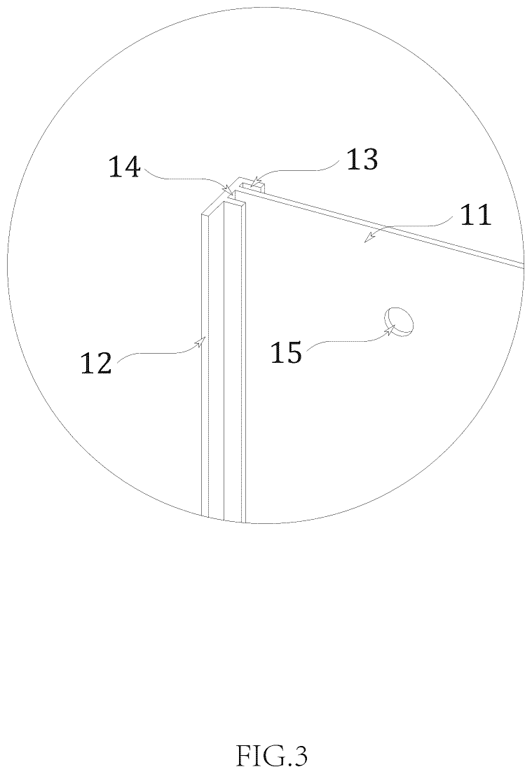

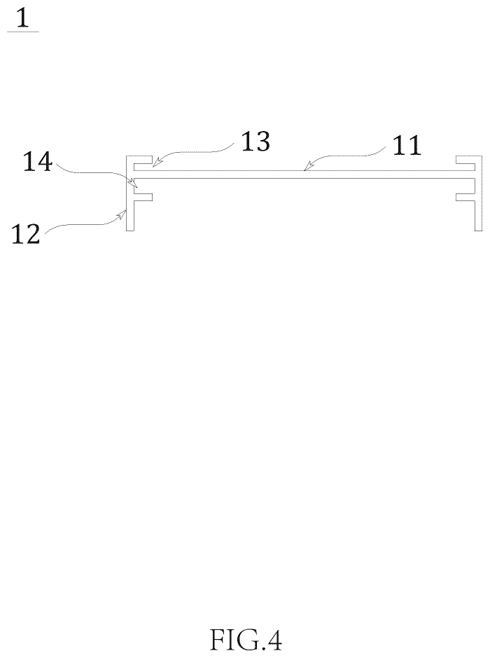

In order to better explain the present application, in one embodiment of the present application, as shown in FIG. 2, FIG. 3 and FIG. 4, border 1 is provided with a long slat-like body part 11, two sides of the main part 11 are respectively provided with a side plate 12, the main part 11 and the side plate 12 are vertical, and a first chute 13 is provided at the connection between one side of the main part 11 and the side plate 12. A second chute 14 is arranged at the connection between the other side of the main part 11 and the side panel 12, and a limited bit hole 15 is arranged on the main part 11.

In the embodiment of the present application, the structural design of the frame 1 makes the assembly process more simple and stable, the vertical structure of the main part 11 and the side panel 12 increases the structural strength of the frame 1, so that it can withstand greater external force and is not easy to deform, the first chute 13 and the second chute 14 provide a convenient connection method for the installation of Angle code 2 and filter cloth 3. The precise positioning and connection between the components are realized by matching with the slide 21 on corner code 2 and the edge of the support plate 31 of the filter cloth 3. The limit hole 15 is matched with the limit block 23 on corner code 2, which further ensures the stability of the connection between the frame 1 and corner code 2 and prevents the displacement of corner code 2 during use.

It should be noted that the length of the main part 11 can be determined according to the design size of the filter element, and its width and thickness should ensure sufficient strength to support the filter cloth 3 and withstand the pressure during the filtration process. The height of the side panel 12 can be adjusted according to needs, for example, when the number of folded layers of the filter cloth 3 needs to be increased, the height of the side panel 12 can be appropriately increased. The depth and width of the first chute 13 and the second chute 14 should match the edge size of the slide 21 of the corner code 2 and the support plate 31 of the filter cloth 3 to ensure smooth sliding and tight connection, and the diameter of the limit hole 15 is slightly larger than the size of the limit block 23, so as to facilitate the installation of the time block 23 can be smoothly inserted and jammed under the action of the elastic piece 22.

### Embodiment 3

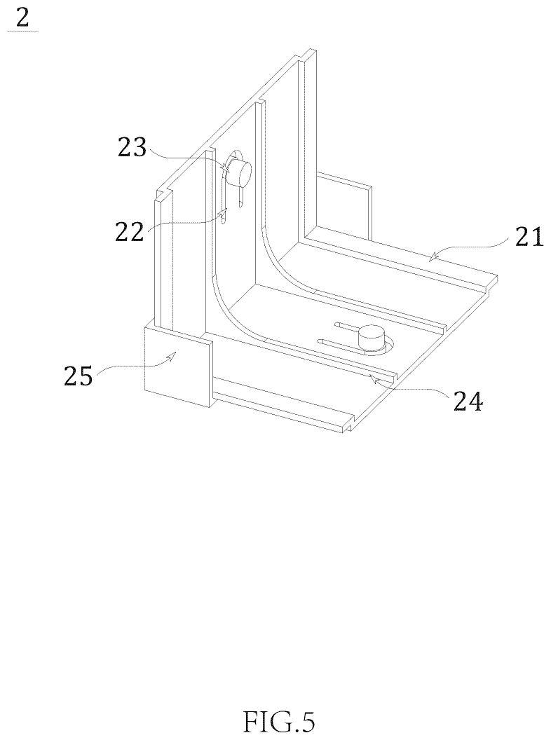

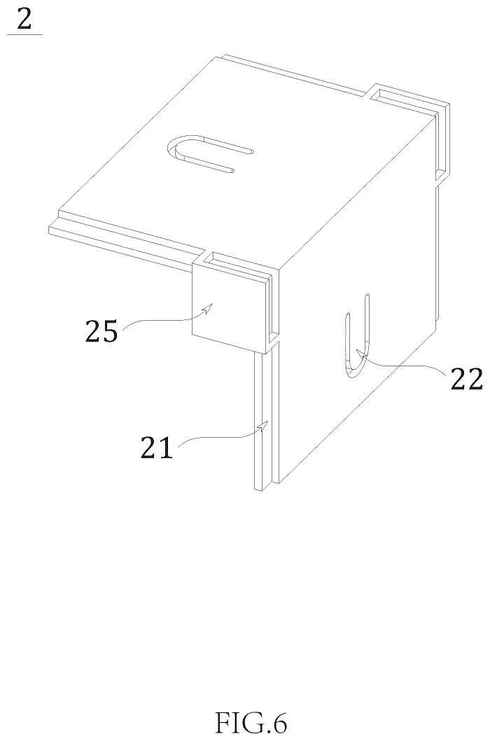

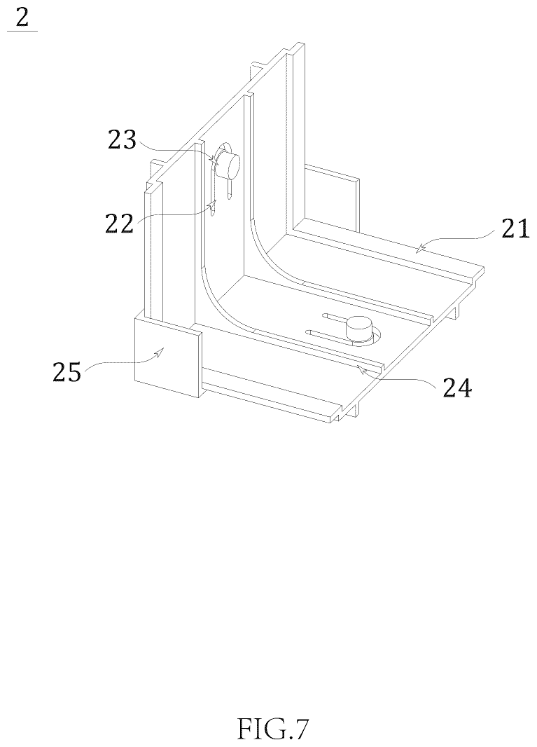

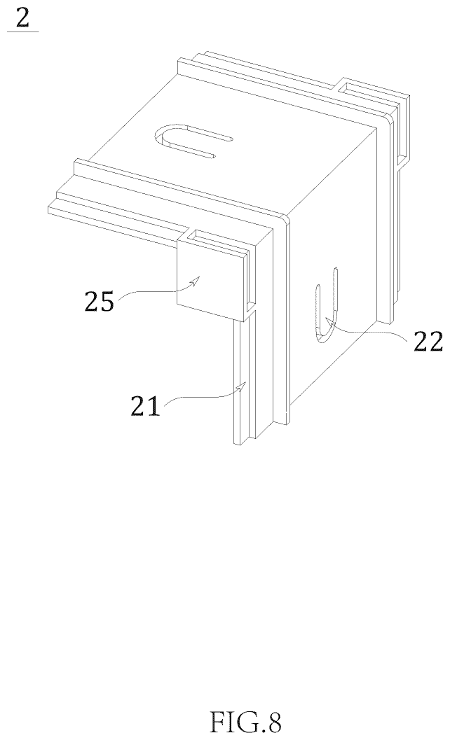

To better explain the present application, in one embodiment of the present application, as shown in FIGS. 5, 6, 7 and 8, a sliding rail 21 is arranged at the side edge of corner code 2, an elastic piece 22 is arranged on corner code 2, and a finite bit block 23 is arranged on the elastic piece 22. When corner code 2 is connected to two adjacent borders 1, the sliding rail 21 is stuck in the first chute 13. And the elastic sheet 22 pushes the limit block 23 to be stuck in the limit hole 15.

In the embodiment of the present application, the structural design of corner code 2 realizes the fast and stable connection with the frame 1, and the coordination of the slide rail 21 with the first chute 13 enables corner code 2 to slide smoothly along the side of the frame 1 during installation and accurately locate at the corner position. The design of the elastic piece 22 and the limit block 23 provides a reliable locking mechanism. After corner code 2 is installed in place, the elastic force of the elastic piece 22 pushes the limit block 23 into the limit hole 15 to prevent corner code 2 from loosening or falling off due to external force. The setting of reinforcement bar 24 and reinforcement plate 25 further enhances the structural strength of corner code 2, making it able to withstand greater tension and pressure, and improving the stability of the entire filter element structure.

It should be noted that the length of the slide 21 should be compatible with the length of the side plate 12 of the frame 1 to ensure that it can be fully embedded in the first chway 13 during the connection process. The material of the elastic sheet 22 should have good elasticity and durability, such as stainless steel spring sheets, etc., and the shape of the limit block 23 can be designed as a semi-spherical or square, etc. To facilitate the smooth insertion of the limit hole 15 and clamping during installation, the number and distribution of reinforcement 24 can be optimized according to the size and force of corner code 2, such as increasing the number or thickness of reinforcement 24 in the part with large force, and strengthening plate 25 can be set inside or outside the bend of corner code 2 to enhance the bending strength at the bend.

### Embodiment 4

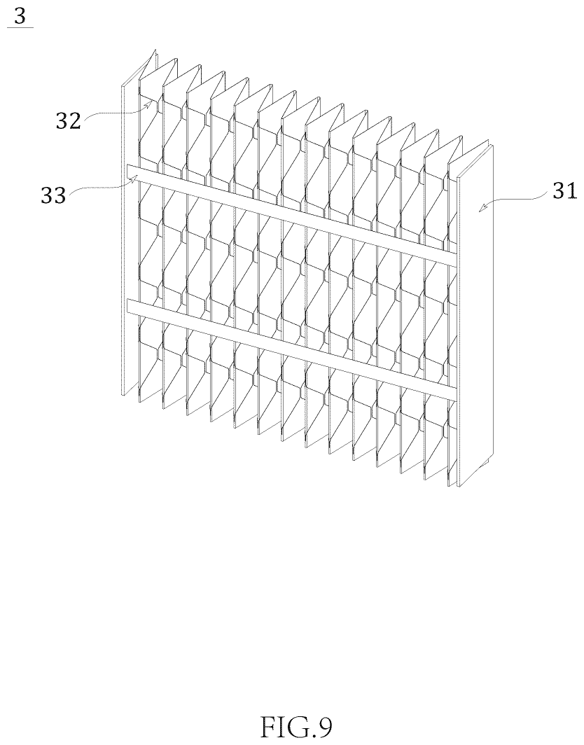

In order to better explain the present application, in one embodiment of the present application, as shown in FIG. 9, the strainer cloth 3 is folded in waves, and two sides of the strainer cloth 3 are respectively provided with a support plate 31. When the strainer cloth 3 is arranged in a rectangular frame, the support plate 31 is arranged on an adjacent frame 1, and the edge of the support plate 31 is stuck in the second chute 14;

At least one of the two faces of the filter cloth 3 is provided with a metal spacer net 32, at least one of the two faces of the filter cloth 3 is provided with a finite position belt 33, the two ends of the limit belt 33 are connected with the two support plates 31, and the main part of the limit belt 33 is connected with the fold of the filter cloth 3.

In the embodiment of the present application, the design of the filter cloth 3 in the shape of wave folding greatly increases the filtering area and improves the filtering efficiency. The support plate 31 provides support for the filter cloth 3, so that it can maintain the wave shape in the filtering process and avoid the deformation or collapse of the filter cloth 3 caused by air impact and other reasons, thus ensuring a stable filtering effect. The function of the metal spacer 32 is to enhance the strength of the filter cloth 3, prevent the filter cloth 3 from being torn or damaged during installation or use, and also help to evenly distribute the air flow and improve the filtration effect. The limit band 33 further fixes the shape of the filter cloth 3 and prevents the folding and displacement of the filter cloth 3 during use.

It should be noted that the folding mode and folding layer number of filter cloth 3 can be adjusted according to actual needs, for example, in the case of high filtration accuracy requirements, you can increase the number of folded layers to improve the filtration area, the material of the support plate 31 can be selected lightweight and high strength plastic or aluminum alloy, its thickness and width should be determined according to the size and strength requirements of filter cloth 3. The aperture size of the metal mesh 32 should be selected according to the filter object to ensure that it can enhance the strength of the role, without affecting the filtering effect, the material of the limit belt 33 can be selected with a certain elasticity of rubber or fiber belt, etc., its width and thickness should be moderate, both can effectively fix the fold of the filter cloth 3, and will not cause too much resistance to the air flow through;

It should also be noted that for general air purification, ordinary non-woven material can be selected, which has a low cost and can meet the basic filtration needs, and in places with high air quality requirements, such as medical operating rooms, laboratories, etc., nano-fiber filter cloth 3 can be selected, which has higher filtration accuracy and can effectively filter out smaller particles to ensure that air quality meets high standards. Further improve the applicability of the filter element in different scenarios.

In addition, the main part 11 and two sides are formed in one body, the stiffener 24 is arranged on the corner code 2, the stiffener 25 is arranged at the bend of the corner code 2, and the filter cloth 3 is bonded with the support plate 31.

Finally, it should also be noted that in the actual production process, it is first necessary to accurately prepare four borders 1 according to the design requirements of the filter element, ensure the dimensional accuracy of the main part 11 and the side plate 12 as well as the processing quality of the first chute 13, the second chute 14 and the limit hole 15, and then the filter cloth 3 with the wave folding shape and the support plate 31. Stick the edge of the support plate 31 into the second chute 14, ensure that the metal spacer 32 and the limit belt 33 are installed correctly, and then align the Angle code 2 slide rail 21 with the first chute 13 of the frame 1, slide in and make the limit block 23 on the elastic sheet 22 stick into the limit hole 15, complete the assembly of four borders 1 and four corner code 2, forming a stable rectangular frame. Finally complete the production of the filter element, the whole process needs to strictly control the quality to ensure the excellent performance of the filter element.

In summary, according to the filter element of the present application, a closed rectangular frame is formed by connecting four borders 1 end to end, and the four corner code 2 is connected and reinforced at the corner position of the rectangular frame, and the stability and durability of the entire filter element structure is enhanced with the internal filter cloth 3, which can make the filter cloth 3 better unfold and maintain its shape, and improve the filtration efficiency of the filter cloth 3. It not only prolonging the service life of the filter element, but also easy to maintain and replace, and meet the application needs of different occasions, especially those with high requirements for air quality.

In the description of the present application, it is necessary to understand that, The term “center”, “vertical”, “horizontal”, “length”, “width”, “thickness” and “up”, “down”, “before” and “after”, “left”, “right” and “vertical”, “level”, “top”, “bottom”, “inside” and “outside”, “clockwise” and “rotate”, “axis”, “radial” and “to the” instructions for the location or position relations The orientation or position relationships based on the attached drawings are only for the purpose of facilitating the description of the present application and simplifying the description, but not to indicate or imply that the device or element referred to must have a specific orientation, construction and operation in a specific orientation, and therefore cannot be understood as a limitation of the present application.

In addition, the terms “first” and “second” are used for descriptive purposes only and are not to be understood as indicating or suggesting relative importance or as implicitly indicating the quantity of the technical features indicated. Thus, a feature qualified as “first” or “second” may explicitly or implicitly include one or more of those features. In the description of the present present application, “multiple” means two or more features, unless otherwise expressly specified.

In the present present application, the terms “installation”, “connection”, “connection”, “fixed”, etc. shall be understood broadly, unless otherwise expressly specified and limited, for example, they may be fixed connections, they may be detachable connections, or they may be one; It may be a mechanical connection or an electrical connection; It can be directly connected, or indirectly connected through an intermediate medium, it can be the connection within the two components or the interaction between the two components. For persons of ordinary skill in the art, the specific meaning of the above terms in the present present application can be understood according to the specific circumstances.

In the present present application, unless expressly specified and limited otherwise, the first feature “above” or “below” the second feature may be the first and second feature in direct contact, or the first and second feature in indirect contact through an intermediate medium. Furthermore, where the first feature is “above”, “above” and “above” the second feature, the first feature is directly above or diagonally above the second feature, or merely indicates that the first feature is at a higher level than the second feature. The first feature being “below”, “below” and “below” the second feature can mean that the first feature is directly or diagonally below the second feature, or simply that the first feature is less horizontal than the second feature.

In the description of this specification, the reference terms “an embodiment”, “some embodiments”, “examples”, “specific examples”, or “some examples”, etc., refer to the specific features, structures, materials, or features described in conjunction with the embodiment or example as contained in at least one embodiment or example of the present present application. In this specification, the schematic expression of the above terms must not be directed to the same embodiment or example. Furthermore, the specific features, structures, materials or features described may be combined in an appropriate manner in any one or more embodiments or examples. In addition, without contradicting each other, persons skilled in the art may combine and combine the different embodiments or examples described in this specification and the features of different embodiments or examples.

Notwithstanding that embodiments of the present application have been shown and described above, it is understood that the said embodiments are exemplary and cannot be construed as limitations of the present application, and that persons of ordinary skill in the art may vary, modify, replace and variant the said embodiments within the scope of the present application.

What is claimed is:

1. A filter element, which is characterized by: including: four borders, four corner codes and filter cloth, among which,
Four of the borders are connected end to end and form a closed rectangular frame, four of the corner code are arranged in the corner position of the rectangular frame, each of the corner code is used to connect two adjacent borders, the filter cloth is arranged in the rectangular frame.

2. The filter element according to the claim 1, which is characterized by the border is set up with a long slate-like main part, the main part of the two sides are set up a side plate, the main part and the side plate vertical, the main part of the side and the side plate is set up at the connection of the first chute, The other side of the main body part and the connection of the side plate is provided with a second chute, the main body part is provided with a limited hole.

3. The filter element according to the claim 2, it is characterized in that the side edge of the corner code is provided with a slide rail, the corner code is provided with an elastic sheet, the elastic sheet is provided with a limited bit block, when the corner code is connected to the adjacent two frames, the slide rail is stuck in the first chute, and the elastic sheet pushes the limit block is stuck in the limit hole.

4. The filter element according to the claim 2, its characteristic is that the filter cloth is a wave folding shape, the two sides of the filter cloth are respectively provided with a support plate, when the filter cloth is set in the rectangular frame, the support plate is set in an adjacent frame, and the edge of the support plate is stuck in the second chute.

5. The filter element according to the claim 2, it is characterized in that the main part and the two sides are formed in one body.

6. The filter element according to the claim 3, the filter element is characterized in that the corner code is provided with reinforcing bars.

7. The filter element according to the claim 3, it is characterized in that the corner code is provided with a strengthening plate at the bending place.

8. The filter element according to the claim 4, the filter cloth is characterized by bonding with the support plate.

9. The filter element according to the claim 4, the filter element is characterized in that at least one of the two faces of the filter cloth is provided with a metal spacer.

10. The filter element according to the claim 4, the filter element is characterized in that at least one of the two surfaces of the filter cloth is provided with a limited bit belt, the two ends of the limit belt are connected with the two support plates respectively, and the main part of the limit belt is connected with the fold of the filter cloth.
